(19) United States
(12) Patent Application Publication
(10) Pub. No.: US 2008/0101692 A1
(43) Pub. Date: May 1, 2008

(54) IMAGE DATA CONVERSION DEVICE AND IMAGE DISPLAY DEVICE

(75) Inventors: Susumu Tanase, Kadoma (JP); Takaaki Abe, Osaka (JP); Masutaka Inoue, Hirakata (JP)

Correspondence Address: MOTS LAW, PLLC, 1001 PENNSYLVANIA AVE. N.W., SOUTH, SUITE 600, WASHINGTON, DC, 20004, US

(73) Assignee: SANYO ELECTRIC CO., LTD., Moriguchi (JP)

(21) Appl. No.: 11/923,744

(22) Filed: Oct. 25, 2007

(30) Foreign Application Priority Data
Oct. 25, 2006 (JP) JP2006-289341

(51) Int. Cl. G06K 9/00

(52) U.S. Cl. 382/162

(57) ABSTRACT

An image data conversion device includes an image data input unit to which image data formed of a plurality of first pixel data, each including values of three basic colors of red, green and blue, is inputted; and a color converter configured to convert first pixel data into second pixel data including at least the values of the three basic colors and a value of a fourth color, by processing each of the plurality of first pixel data forming the image data. The color converter includes a controller configured to control changes in the value of the fourth color included in the second pixel data corresponding to the first pixel data, on the basis of the values of the three basic colors included in the first pixel data.

### CROSS REFERENCE TO RELATED APPLICATIONS

This application is based upon and claims the benefit of priority from prior Japanese Patent Application No. 2006-289341, filed on October 25; the entire contents of which are incorporated herein by reference.

### BACKGROUND OF THE INVENTION

1. Field of the Invention

The present invention relates to an image data conversion device and an image display device. In particular, it relates to an image data conversion device configured to convert image data in which one pixel is formed of three color values into image data in which one pixel is formed of four color values, and to an image display device.

2. Description of the Related Art

In recent years, there has been developed a liquid crystal projector in which three colors of red (R), green (G), and blue (B), and a fourth color that is different from the three colors, that is, all the colors are reproduced by the four colors. However, it is not easy to convert three color values into four color values. Thus, there is a problem that an image after conversion often looks strange.

For example, in Japanese Patent Publication No. Heisei, 11-174583, disclosed is a projector including: a color light separator for separating a light beam from a light source into at least four colors of predetermined three colors and an arbitrary color; a white detection unit for determining, based on a inputted image data, whether or not the image data is a signal showing an white image; a modulation signal generator for generating a modulation signal for each of the predetermined three colors and a modulation signal for the arbitrary color being a signal of zero level on the basis of the inputted image data when white is not detected by the white detection unit, and generating a modulation signal for each of at least the four color light beams after adjusting the level of the inputted image data so as to emphasize white when white is detected by the white detector; a modulator for performing modulation for each color of the separated light beams on the basis of the generated modulation signal for each color; and a projector for combining the modulated light beams and project the combined light beam.

However, when an image data is not a signal showing a white image, such a conventional projector reproduces the image data with only three colors of R, G, and B and when the image data is a signal showing a white image, the conventional projector reproduces the image data with four colors. Thus, there is a problem that luminance of white can be improved but color reproducible range cannot be expanded because the color reproducible range lies within the limit of the reproducible range of three colors of R, G, and B. There is also a problem that luminance of a color other than white cannot be improved.

### SUMMARY OF THE INVENTION

One aspect of the present invention is to provide an image data conversion device including: image data input unit to which image data formed of a plurality of first pixel data, each including values of three basic colors of red (R), green (G), and blue (B), is inputted; and a color converter configured to convert first pixel data into second pixel data including at least values of three basic colors and a fourth color, by processing each of the plurality of first pixel data forming the inputted image data. The color converter includes a controller configured to control changes in a value of the fourth color included in the second pixel data corresponding to the first pixel data, on the basis of the values of the three basic colors included in the first pixel data.

According to this aspect, the changes in value of the fourth color included in the second pixel data corresponding to the first pixel data is controlled on the basis of the values of the three basic colors included in the first pixel data, when each of the plurality of first pixel data forming image data is converted into the second pixel data including the values of the three basic colors and the fourth color. Since the value of the fourth color is changed on the basis of the values of the three basic colors included in the first pixel data, an image to be displayed will be an image with less strangeness than the case where the value of the fourth color is set to be a value to be uniquely determined for the value of the first pixel data. In addition, when the fourth color is a color of outside the color reproducible range of the three basic colors, the color reproducible range of image data after conversion can be expanded.

It is preferable that the controller includes a first controller configured to determine the value of the fourth color included in the second pixel data corresponding to the first pixel data to be smaller as chromaticity coordinates of the first pixel data is closer to chromaticity coordinates of white, and determine the value of the fourth color included in the second pixel data corresponding to the first pixel data to be larger as the chromaticity coordinates of the first pixel data is closer to the chromaticity coordinates of the fourth color.

It is preferable that the controller include a second color controller configured to determine the value of the fourth color included in the second pixel data to be smaller as the number of colors included in the inputted image data is larger.

According to this aspect, as the number of colors included in the image data is larger, the value of the fourth color is set to be smaller, so that data capable of displaying an image without strangeness can be generated.

It is preferable that the color converter include a gain-value determiner configured to determine a gain-value for increasing the value of the fourth color included in the second pixel data corresponding to the first pixel data, on the basis of the three basic colors included in the first pixel data.

According to this aspect, the gain-value for increasing the value of the fourth color is determined on the basis of the three basic colors included in the first pixel data. Thus, for example, it is possible that the gain-value is varied for each of the values of the three basic colors or for each of pixels with high and low luminance values. As a result, it is possible that data in which contrast of an image to be displayed is improved can be generated.

It is preferable that the controller include a first gain-value controller configured to determine the gain-value in proportion to any one of each of the values of the three basic colors in the first pixel data and a luminance value specified by the values of the three basic colors included in the first pixel data, when each of the values of the three basic colors is in a predetermined range of when the luminance value specified by the values of the three basic colors is in a predetermined range.

According to this aspect, the gain-value increases as the first pixel data comes closer to the three basic colors or the luminance value becomes higher. Thus, the luminance of a bright portion of an image to be displayed can be improved.

It is preferable that the controller includes a second gain-value controller configured to determine the gain-value to be a smaller as the number of colors included in the inputted image data is larger.

If the number of colors included in the image data is large, strangeness tends to be caused in an image after increasing the luminance. For this reason, as the number of the colors included in the image data is larger, the gain-value is set to be smaller, so that the data corresponding to colors of the image to be displayed without strangeness can be generated.

It is preferable to further include a sharpness unit configured to sharpen an image formed of the value of the fourth color included in each of a plurality of the second pixel data, acquired by converting the plurality of first pixel data with the color converter.

According to this aspect, the image formed of the value of the fourth color included in each of the plurality of second pixel data is sharpened. Thus, the number of processing and circuits can be reduced when compared with a case where all the three basic colors are sharpened. As a result, it is possible to perform sharpening processing on data in which the number of colors included in one pixel is increased with a simple circuit.

It is preferable that the color converter includes: a separator configured to separate the first pixel data into white components having same values of the three basic colors and residual components other than the white components; a white component converter configured to generate white component corresponding data including at least values of the three basic colors and fourth color on the basis of the white components separated by the separator; a residual component converter configured to generate residual component corresponding data including at least the values of the three basic colors and fourth color on the basis of the residual components separated by the separator; and an addition unit configured to output the second pixel data, acquired by adding respective value of the same color, included in the white component corresponding data and the residual component corresponding data. The residual component converter includes a controller configured to control the changes in the value of the fourth color included in the second pixel data corresponding to the first pixel data based on the values of the three basic colors included in the residual component corresponding data.

According to this aspect, the first pixel data is separated into the white components and the residual components, and the white component corresponding data including at least the values of the three basic colors and fourth color is generated on the basis of the white components, whereas the residual component corresponding data including at least three basic colors and a fourth color on the basis of the residual components is generated on the basis of the residual components. Then, the value of a same color is added to each of the white component corresponding data and the residual component corresponding data. Since the white components and the residual components are converted separately, it becomes easy to convert the values of the three basic colors into the values of the four colors. In particular, if the three basic colors show white, it is only needed to determine each of the values of the four colors so that white would be generated by the four colors in the white component corresponding data. Thus, the white balance can be easily adjusted. As a result, a color of data in which the number of colors included in one pixel is increased can be easily determined.

According to another aspect of the present invention, an image display device includes the image data conversion device and display unit configured to display image data, the image data formed of a plurality of pixels respectively formed of a plurality of colors including at least three basic colors. The image data is outputted by the image data conversion device.

It is preferable that the fourth color be a color of outside the range reproducible by the three basic colors.

According to this aspect of the present invention, the image display device includes: an image data input unit to which image data formed of the plurality of first pixel data, each including values of three basic colors of red, green, and blue, is inputted; a color converter configured to convert the first pixel data into second pixel data including at least the values of the three basic colors and a value of a fourth color by processing each of the plurality of first pixel data forming the inputted image data; and a sharpness unit configured to sharpen an image formed by the value of the fourth color included in each of the plurality of second pixel data, into which the plurality of first pixel data is converted by the color converter.

According to another aspect of the present invention, the image data conversion device includes: an image data input unit to which image data formed of the plurality of first pixel data, each including values of three basic colors of red, green, and blue, is inputted; and a color converter configured to convert the first pixel data into second pixel data including at least the values of the three basic colors and a value of a fourth color by processing each of the plurality of first pixel data forming the inputted image data. The color converter includes: a separator configured to separate the first pixel data into white components having same values of the three basic colors, and residual components other than the white components; a white component converter configured to generate white component corresponding data including the values of the three basic colors and the fourth color on the basis of the white components separated by the separator; a residual component converter configured to generate residual component corresponding data including the values of the three basic colors and the fourth color on the basis of the residual components separated by the separator; and an addition unit configured to output the second pixel data, acquired by adding respective value of the same color, included in the white component corresponding data and the residual component corresponding data.

It is preferable that the residual component converter include a fourth color determiner configured to determine the value of the fourth color included in the residual component corresponding data, on the basis of the values of the three basic colors included in the residual components, and a three basic color calculator configured to calculate the values of the three basic colors included in the residual component corresponding data by subtracting the values of the three basic colors corresponding to the value of the fourth color determined from the values of the three basic colors included in the residual components.

It is preferable that the fourth color determiner include a first color controller configured to determine the value of the fourth color included in the residual component corresponding data to be smaller as the chromaticity coordinates of the first pixel data is closer to the chromaticity coordinates of white, and determine the value of the fourth color included in the residual component corresponding data to be larger as the chromaticity coordinates of the first pixel data is closer to the chromaticity coordinates of the fourth color.

It is preferable that the fourth color be a color of outside the range reproducible with the three basic colors.

It is preferable that the fourth color determiner include a second color controller configured to determine the value of the fourth color included in the residual component corresponding data to be smaller as the number of colors included in the inputted image data is larger.

It is preferable that the color converter further include a gain-value determiner configured to determine a gain-value for increasing the value of the fourth color included in the second pixel data corresponding to the first pixel data, on the basis of the three basic colors included in the residual components. The addition unit further adds the determined gain-value to the value that the value of the fourth color included in the white component corresponding data and the value of the fourth color included in the residual component corresponding data are added.

It is preferable that the gain-value determiner include a first gain-value controller configured to determine a gain-value in proportion to each of the values of the three basic colors included in any one of the first pixel data and the luminance value specified by the values of the three basic colors included in the first pixel data, when each of the values of the three basic colors is in a predetermined range or when the luminance value specified by the values of the three basic colors is in a predetermined range.

It is preferable that the gain-value determiner includes a second gain-value controller configured to determine the gain-value to be smaller as the number of colors included in the inputted image data is larger.

It is preferable to further include a sharpness unit configured to sharpen an image formed of the value of the fourth color included in each of the plurality of second pixel data into which the first pixel data is converted by the color converter.

### BRIEF DESCRIPTION OF THE DRAWINGS

FIG. 1 is a block diagram showing a circuit configuration of a liquid crystal projector according to a first embodiment of the present invention;

FIG. 2 is a functional block diagram showing a function of a controller;

FIG. 3 is a view showing a chromaticity coordinate system;

FIG. 4 is a graph showing one example of a relationship of a variable a1 and a minimum value of a component of first pixel data;

FIG. 5 is a graph showing one example of a relationship of a variable a2 and a maximum value of a fourth color component of the first pixel data;

FIG. 6 is a graph showing a relationship of a second conversion rate β and a value of each component or luminance of the first pixel data;

FIG. 7 is a functional block diagram showing a function of a controller according to a first modification;

FIGS. 8A and 8B are views showing one example of a histogram of the number of pixels for each color;

FIG. 9 is a view showing one example of a relationship of a first conversion rate c1 and the number of colors of image data;

FIG. 10 is a view showing one example of a relationship of a second conversion rate β and the number of colors of image data;

FIG. 11 is a functional block diagram showing a function of a controller according to a second modification; and

FIG. 12 is a block diagram showing a circuit configuration of a liquid crystal projector according to a second embodiment.

### DETAILED DESCRIPTION OF THE EMBODIMENTS

Embodiments of the present invention will be described below by referring to the drawings. In the following description, same reference numerals are given to denote same components, and names and functions thereof are also same. Thus, the description thereof will not be repeated.

### First Embodiment

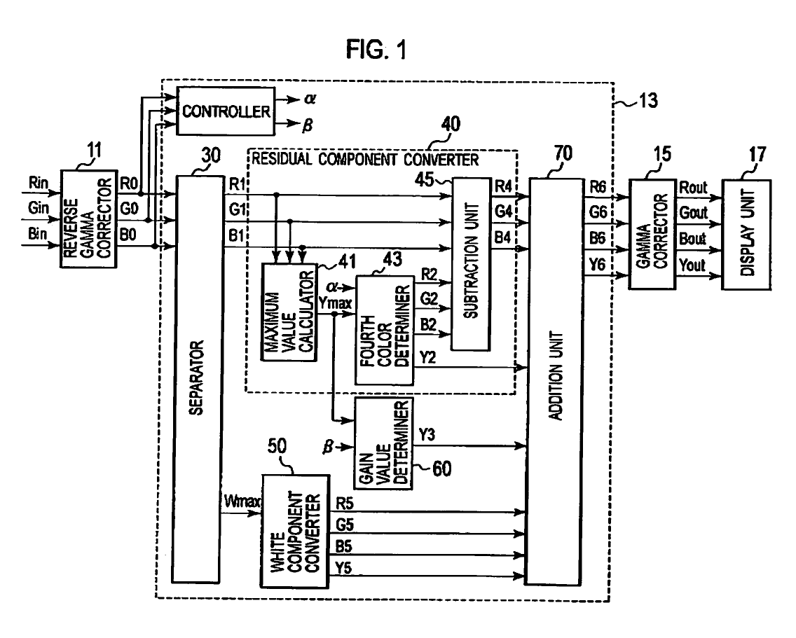

FIG. 1 is a block diagram showing a circuit configuration of a liquid crystal projector according to a first embodiment of the present invention. Referring to FIG. 1, a liquid crystal projector 1 includes a reverse gamma corrector 11, a color converter 13 being an image data conversion device, a gamma corrector 15, and a display unit 17.

Image data that is formed of a plurality of pixel data, each including values of three basic colors of red (R), green (G), and blue (B) and a fourth color other than the three basic colors, is inputted to the display unit 17. The fourth color is an arbitrary color but other than R, G, and B. It is preferable that the fourth color be a color outside a color range reproducible by the three basic colors of R, G, and B. Here, the description will be given by taking an example of a case where the fourth color is yellow (Y) which is outside the range reproducible by the three basic colors of R, G, and B. Note that image data may be formed of a plurality of pixel data, each including values of three basic colors of R, G, and B and values of a plurality of colors other than the three basic colors. In addition, the display unit 17 has filters for a total of four colors of the three basic colors of R, G, and B and the fourth color of Y. A light beam emitted from a light source is separated into four color light beams, and each of the four color light beams is modulated based on image data to be inputted. Then, the four color light beams are combined and projected so that an image is projected on a projection plane. Here, the description will be given by taking the liquid crystal projector 1 as an example, but it may be a liquid crystal display device, a plasma display panel, an organic EL, or the like as long as it is a display device in which one pixel is formed of sub-pixels with at least four colors.

Image data that is formed of a plurality of pixel data, each including values of three basic colors of R, G, and B (Rin, Gin, Bin), is inputted to the reverse gamma corrector 11. The reverse gamma corrector 11 is configured to perform gamma correction processing for each plurality of pixel data. The pixel data to be inputted to the reverse gamma corrector 11 has been performed the gamma correction processing according to the characteristics of the display unit 17. For this reason, the reverse gamma corrector 11 converts the pixel data being performed the gamma correction processing according to the characteristics of the display unit 17 into first linear pixel data and outputs the first pixel data (R0, G0, B0) to the color converter 13.

The color converter 13 is configured to convert the first pixel data (R0, G0, B0) inputted from the reverse gamma corrector 17 into second pixel data (R6, G6, B6, Y6) formed of values of the three basic colors of R, G, and B, and fourth color of Y, and configured to output the second pixel data to the gamma corrector 15.

The gamma corrector 15 is configured to perform gamma correction processing on the second pixel data (R6, G6, B6, Y6). The second pixel data (R6, G6, B6, Y6) to be inputted to the gamma corrector 15 are linear pixel data. Thus, the gamma corrector 15 performs the gamma correction processing on the second pixel data according to the characteristics of the display device 17 and outputs the second pixel data after the gamma correction processing (Rout, Gout, Bout, Yout) to the display unit 17.

The color converter 13 includes a controller 20, a separator 30, a residual component converter 40, a white component converter 50, a gain-value determiner 60, and an addition unit 70. The first pixel data (R0, G0, B0) is inputted to the controller 20. Then, the controller 20 determines a first conversion rate α and a second conversion rate β based on the first pixel data (R0, G0, B0) or a plurality of first pixel data and outputs the first conversion rate α to the residual component converter 40 and to output the second conversion rate β to the gain-value determiner 60. The function of the controller 20 will be described in detail later.

The first pixel data (R0, G0, B0) is inputted to the separator 30. Then, the separator 80 separates the first pixel data (R0, G0, B0) into white components (Wmax, Wmax, Wmax) and residual components (R1, G1, B1) and outputs the white components to the white color converter 50 and the residual components to the residual component converter 40. The white components (Wmax, Wmax, Wmax) are maximum values of the white components included in the first pixel data and minimum values (Wmax=MIN(R0, G0, B0)) of the components of the first pixel data (R0, G0, B0). The residual components (R1, G1, B1) are components obtained by subtracting the white components (Wmax, Wmax, Wmax) from the first pixel data (R0, G0, B0). R1=R0·Wmax, G1=G0·Wmax, B1=B0−Wmax. For example, the separator 80 separates the first pixel data (130, 100, 70) into white components (70, 70, 70) and residual components (50, 30, 0).

The white component converter 50 is configured to convert the white components (Wmax, Wmax, Wmax) to be inputted from the separator 30 into white component corresponding data (R5, G5, B5, Y5) including values of three basic colors and a fourth color. The white component converter 50 stores the white component corresponding data (R5, G5, B5, Y5) on a predefined white component conversion table for each of values that the white components (Wmax, Wmax, Wmax) possibly take, and determines the white component corresponding data (R5, G5, B5, Y5) according to the conversion table. The white component conversion table is a table that white balance of the white component corresponding data (R5, G5, B5, Y5) is adjusted.

The residual component converter 40 is configured to convert the residual components (R1, G1, B1) to be inputted from the separator 30 into residual component corresponding data (R4, G4, B4, Y2) including values of three basic colors and a fourth color. The residual component converter 40 includes a maximum value calculator 41, a fourth color determiner 43, and a subtraction unit 45. The residual components (R1, G1, B1) are inputted from the separator 30 to the maximum value calculator 41. Then, the maximum value calculator 41 determines a maximum value Ymax that the fourth color Y possibly takes according to the residual components (R1, G1, B1) and outputs the maximum value Ymax to both the fourth color determiner 43 and the gain-value determiner 60. Since the fourth color is set to be yellow (Y) here, the maximum value Ymax that the fourth color Y can take is the minimum value of R1 and G1 of the residual components (R1, G1, B1) including a Y component. Ymax=MIN(R1, G1)

The maximum value Ymax and the first conversion rate α are inputted to the fourth color determiner 43. Then, a value Y2 of the fourth color Y is determined by multiplying the maximum value Ymax and the first conversion rate α, and the value Y2 is outputted to the adder 70. Y2=Ymax×α(0≦α≦1). The first conversion rate α is a value determined by the controller 20. The value Y2 is a Y component of the residual component corresponding data. In addition, the fourth color determiner 43 outputs components (R2, G2, B2) of R, G, and B, each corresponding to the value Y2 of the fourth color Y, to the subtraction unit 45. Since the value of the fourth color Y is determined to be Y2, R2=Y2, G2=Y2, and B2=0.

The residual components (R1, G1, B1) and each of the components of R, G, and B (R2, G2, B2), each corresponding to the value Y2 of the fourth color, are inputted from each of the separator 30 and the forth color determiner 43 to the subtraction unit 45. The subtraction unit 45 subtracts each of the components of R, G, and B (R1, G1, B1), each corresponding to the value Y2 of the fourth color Y, from the residual components (R1, G1, B1), so that the components of R, G, and B (R4, G4, B4) of the residual component corresponding data are calculated and the calculated components are outputted to the addition unit 70. R4=R·R2, G4=G·G2, and B4=B1−B2.

The maximum value Ymax and the second conversion rate β are inputted to the gain-value determiner 60. Then, a gain-value Y3 to be added to the fourth color Y is determined by multiplying together the maximum value Ymax and the second conversion rate 8, and the determined gain-value Y3 is outputted to the addition unit 70. Y3=Ymax×β(0≦β≦1). The second conversion value β is a value determined by the controller 20.

The addition unit 70 adds the residual component corresponding data (R4, G4, B4) to be inputted from the residual component converter 40, the white component corresponding data (R5, G5, B5, Y5) to be inputted from the white component converter 50, and the gain-value Y3 to be inputted from the gain-value determiner 60 for each of the R, G, B, and Y components, and outputs the second pixel data (R6, G6, B6, Y6). R6=R4+R5, G6=G4+G5, B6=B4+B5, and Y6=Y2+Y5+Y3.

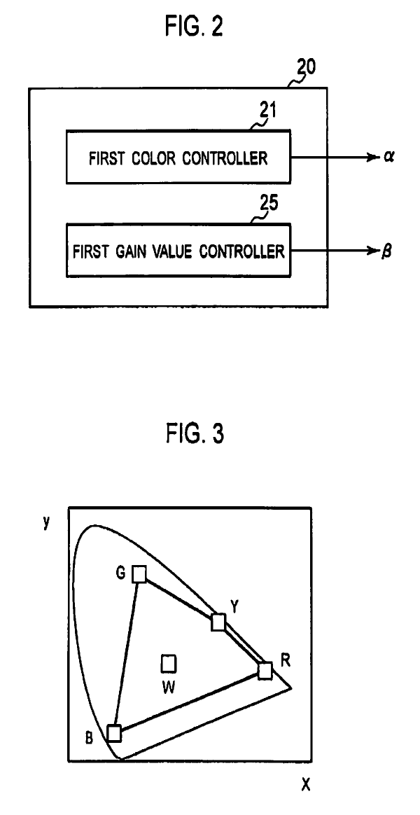

FIG. 2 is a functional block diagram showing a function of the controller. Referring to FIG. 2, the controller 20 includes a first color controller 21 and a first gain-value controller 25. The first color controller 21 determines a first conversion rate α to be smaller as chromaticity coordinates of the first pixel data (R0, G0, B0) come closer to chromaticity coordinates of white and determines a first conversion rate α to be larger as the chromaticity coordinates of the first pixel data come closer to the chromaticity coordinates of the fourth color (Y).

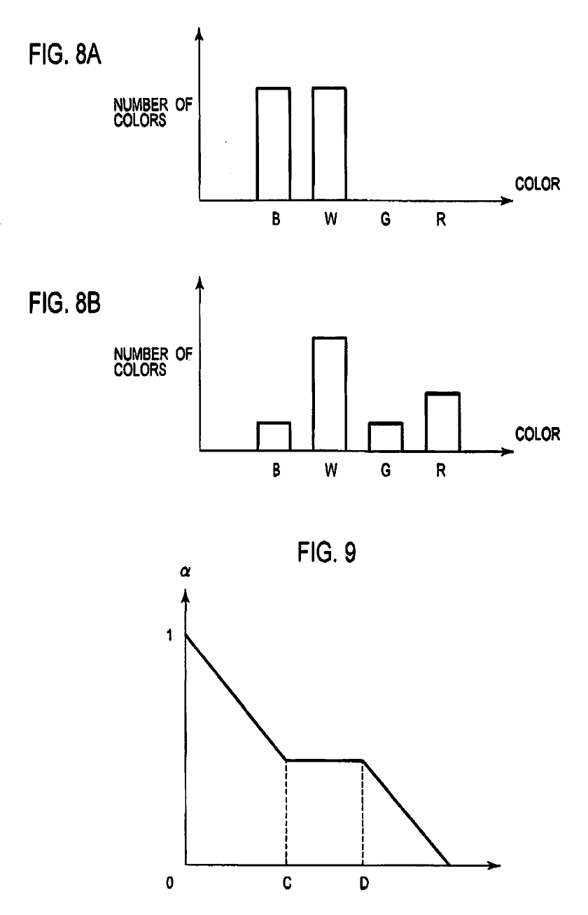

Here, the description will be given to the first conversion rate α by using the chromaticity coordinates shown in FIG. 8. Referring to FIG. 3, the fourth color Y is located outside the triangle having X, G, and B as vertexes. It is preferable that the chromaticity coordinates of the second pixel data be close to the chromaticity coordinates W of white when the chromaticity coordinates of the first pixel data are close to the chromaticity coordinates W of white. This is because white before conversion is to be made white even after conversion. For this reason, it is preferable that the value of the fourth color (Y) be set to be smaller if the chromaticity coordinates of the first pixel data come close to the chromaticity coordinates W of white. In contrast, as the chromaticity coordinates of the first pixel data are closer to the chromaticity coordinates Y of the fourth color, the components of the fourth color are made larger, so that the fourth color can be determined. In particular, if the chromaticity coordinates are located outside the triangle having R, G, and B as vertexes, the color reproducible range can be expanded. Since the chromaticity coordinates of the first pixel data are located inside the triangle having R, G, and B as vertexes and the chromaticity coordinates Y of the fourth color are located outside the triangle having R, G, and B as vertexes, if the chromaticity coordinates of the first pixel data are close to the chromaticity coordinate Y of the fourth color, the color reproducible range can be expanded by causing the fourth color component to be larger. In this case, as the chromaticity coordinates of the first pixel data are close to the chromaticity coordinates Y of the fourth color, the components of the fourth color are made larger, so that the color reproducible range can be evenly expanded.

Next, the specific example of determining the first conversion rate α will be described. The first color controller 21 defines the first conversion rate α by a product of two variables a1 and a2, and obtains the first conversion rate α by determining the variables a1 and a2.

α=a1×a2 (1)

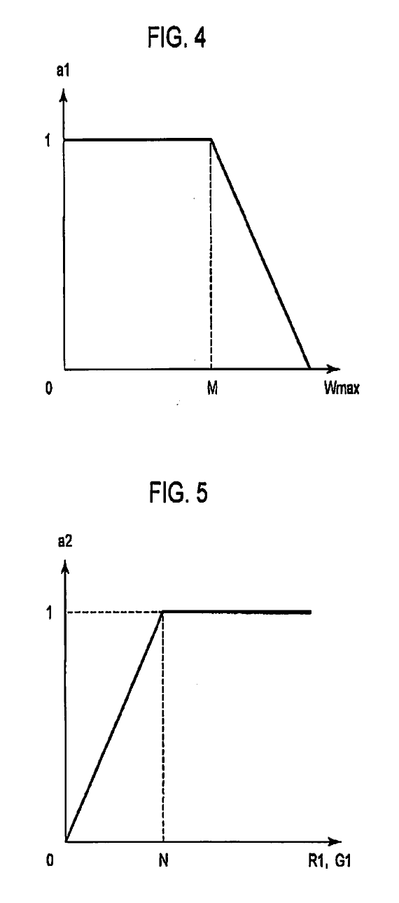

The variable a1 is determined on the basis of the minimum value of the components of the first pixel data (R0, G0, B0) (Wmax=MIN(R0, G0, B0)). FIG. 4 shows one example of a relationship of the variable a1 and the minimum value Wmax of the components of the first pixel data. The variable a1 becomes 1 if the minimum value (Wmax) of the components of the first pixel data (R0, G0, B0) is smaller than a threshold value M, and becomes smaller as the minimum value Wmax increases if it is larger than the threshold value M. Thus, the variable a1 is a component to cause the first conversion rate α to be a smaller value in the equation (1) as the chromaticity coordinates of the first pixel data (R0, G0, B0) come closer to the chromaticity coordinates of white. The variable a2 is determined on the basis of the component R0 or G0, whichever is larger, forming the component of the fourth color Y here of the components of the first pixel data (R0, G0, B0) (hereinafter referred to “the maximum value of the fourth color component of the first pixel data”). FIG. 5 shows a relationship of the variable a2 and the maximum value of the fourth color of the first pixel data. The variable a2 becomes 1 if the maximum value of the fourth color component of the first pixel data is larger than a threshold value N, and becomes smaller as the maximum value of the fourth color of the first pixel data decreases if it is smaller than the threshold value N. Thus, the variable a2 is a component to cause the first conversion rate α to be a larger value in the equation (1) as the chromaticity coordinates of the first pixel data come closer to the chromaticity coordinates of the fourth color (Y). Note that the variable a2 is determined by using the maximum value of the fourth color component of the first pixel data here, but the variable a2 may be determined by using the positions of the coordinates of the first pixel data in the chromaticity coordinates and the distance with the straight line between the coordinates R (255, 0, 0) and the coordinates G (0, 255, 0). In this case, it is only needed that the variable a2 is set to be 1 if the distance is longer than 1, and is set to be a value which becomes smaller as the distance becomes shorter if it is smaller than the threshold value.

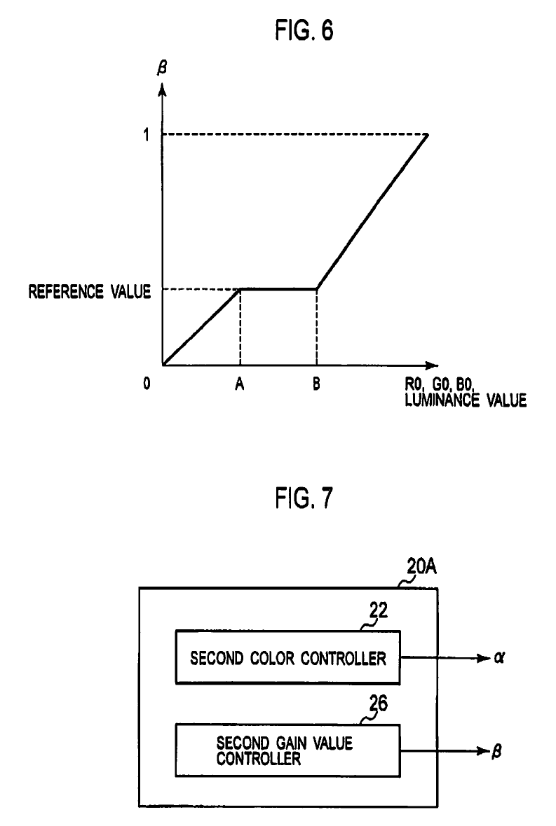

The first gain-value controller 25 is configured to determine the second conversion rate β according to the first pixel data (R0, G0, B0). More specifically, the first gain-value controller 25 determines the second conversion rate β to be a value which is proportional to a value of each component or a luminance value of the first pixel data (R0, G0, B0). FIG. 6 shows a relationship of the second conversion rate β and the value of each component or luminance of the first pixel data (R0, G0, B0). Referring to FIG. 6, the lateral axis shows the value of each color or luminance of the first pixel data (R0, G0, B0) and the longitudinal axis shows the second conversion rate β. The first gain-value controller 26 selects the maximum value from the value of each component or luminance of the first pixel data (R0, G0, B0) as a reference value, and determines the second conversion rate β corresponding to the reference value. The second conversion rate β becomes smaller in proportion to the reference value if the reference value is smaller than a threshold value A, and becomes larger in proportion to the reference value if the reference value is larger than a threshold value B. Note that the description is given here by using a case where the second conversion rate β is not changed when the reference value is between the threshold values A and B, but the second conversion rate β may be a value which changes in proportion to the reference value even between the threshold values A and B.

Since the second conversion rate β is determined in proportion to the reference value, the second conversion rate β is to be determined as a large value if the chromaticity coordinates of the first pixel data are located near the coordinates R, G, and B which are shown in the chromaticity coordinates shown in FIG. 3. In addition, as the luminance value of the first pixel data is higher, the second conversion rate 8 is determined to be a larger value. Since the second conversion rate β is a value for determining the gain-value Y8 of the fourth color value, the gain-value Y8 becomes larger as the chromaticity coordinates of the first pixel data are located near the coordinates R, G, and B in the chromaticity coordinates shown in FIG. 3, or as the luminance value of the first pixel data is higher. For this reason, the luminance is further superposed on the pixel having high luminance, so that contrast can be improved.

Note that in the present embodiment, as described in FIG. 3, the description has been given by using a case where the fourth color is set to be yellow (Y) and the chromaticity coordinates thereof are located outside the triangle having the coordinates R, G, and B as vertexes as an example, but the fourth color may be a color whose chromaticity coordinates are located inside the triangle having the coordinates R, G, and B as vertexes in the chromaticity coordinates shown in FIG. 3. For example, if the color reproducibility of the fourth color with three colors of R, G, and B is deteriorated, or if large power is required at the time when the fourth color is outputted with the three colors of R, G, and B, it is effective that the display unit 17 outputs a color inside the triangle having the coordinates R, G, and B as vertexes in the chromaticity coordinates, in that in the former case, the color reproducibility can be improved and in the latter case, the consumption power of the display unit 17 can be reduced.

### (First Modification of the Controller)

It is possible that the first conversion rate α and the second conversion rate β are changed on the basis of the number of colors included in image data. If the fourth color is set to be yellow (Y) and the chromaticity coordinates thereof are located outside the triangle having the coordinates R, G, and B as vertexes in the chromaticity coordinates shown in FIG. 3, the color reproducible range can be expanded by the color converter 13 as described above. However, if the number of colors included in the image data formed of the plurality of first pixel data is large, there is known from experiences that an image whose color reproducible range are expanded often becomes an image with strangeness. In contrast, if the number of colors included in the image data is small, it is often less likely that the image whose color reproducible range are expanded becomes an image with strangeness. For this reason, the controller 20 in the first modification determines the first conversion rate α and the second conversion rate β according to the number of colors included in the image data.

FIG. 7 is a functional block diagram showing a function of the controller according to the first modification. Referring to FIG. 7, a controller 20A according to the first modification includes a second color controller 22 and a second gain-value controller 26. The first pixel data (R0, G0, B0) are inputted to each of the second color controller 22 and the second gain-value controller 26, and the number of colors included in image data is calculated from the plurality of first pixel data forming the image data. FIGS. 8A and 8B are views showing one example of a histogram of the number of colors for each color, FIG. 5A shows an example of the histogram of image data in which the number of colors is small, and FIG. 8B shows an example of the histogram of image data in which the number of colors is large. The image data shown in FIG. 8A includes many pixels of blue (B) and white (W), and the number of colors therein is small. The image data shown in FIG. 8B reasonably includes pixels of red (R), green (G), blue (B), and white (W), and the number of colors therein is large.

The second color controller 22 is configured to determine the first conversion rate α to be small as the number of colors included in the inputted image data is larger. FIG. 9 shows an example of a relationship of the first conversion rate α and the number of colors included in the image data. The first conversion rate α becomes smaller with the increase of the number of colors when the number of colors is smaller than a threshold value C or when the number of color is larger than a threshold values D. Note that the description has been given by using an example of the case where the first conversion rate α is not changed when the number of colors is between the threshold values C and D, but it is also possible that the first conversion rate α is set to be smaller with the increase of the number of colors even when the number of colors is therebetween.

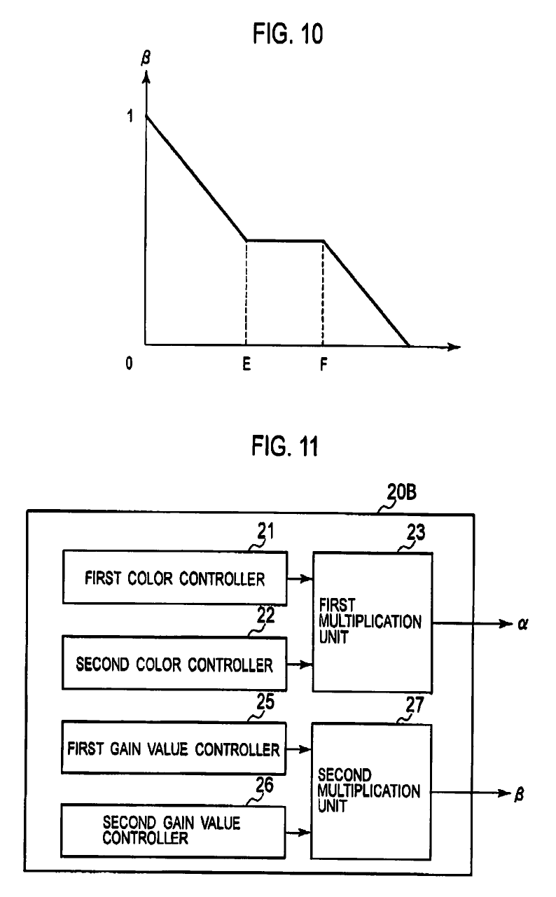

The second gain-value controller 26 is configured to determine the second conversion rate β to be small as the number of colors included in the inputted image data is larger. FIG. 10 shows an example of a relationship of the second conversion rate β and the number of colors included in the image data. The second conversion rate β becomes smaller when the number of colors is smaller than a threshold value E or when the number of colors is larger than a threshold value F. Note that the description has been given here by using an example of the case where the second conversion rate β is not changed when the number of colors is between the threshold values E and F, but it is also possible that the second conversion rate β is set to be smaller with the increase of the number of colors even when the number of colors lies therebetween.

### (Second Modification of the Controller)

The first conversion rate α and the second conversion rate β may be determined in such a manner that the above-mentioned controller 20 and the controller 20A according to the first modification are combined. FIG. 11 is a functional block diagram showing a function of a controller according to a second modification. Referring to FIG. 11, a controller 20B according to the second modification includes a first color controller 21, a second color controller 22, a first gain-value controller 25, a second gain-value controller 26, a first multiplication unit 23, and a second multiplication unit 27. The first color controller 21, the second color controller 22, the first gain-value controller 25, and the second gain-value controller 26 have been described above, and the description thereof will not be repeated here.

The first multiplication unit 23 multiplies the first conversion rate α which is outputted from each of the first color controller 21 and the second controller 22, and outputs the multiplied value as a new first conversion rate α to a fourth color determiner 43. The second multiplication unit 27 multiplies the second conversion rate β which is outputted from each of the first gain-value controller 25 and the second gain-value controller 26, and outputs the multiplied value as a new second conversion rate β to a gain-value determiner 60.

### Second Embodiment

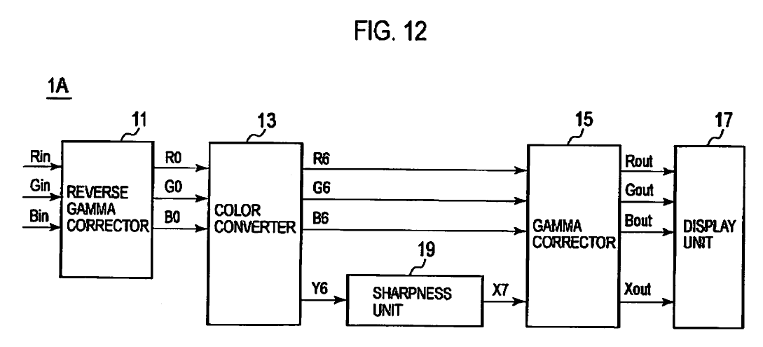

FIG. 12 is a block diagram showing a circuit configuration of a liquid crystal projector according to a second embodiment. A liquid crystal projector 1A includes a reverse gamma corrector 11, a color converter 13 as an image data conversion device, a sharpness unit 19, a gamma corrector 15, and a display unit 17. The reverse gamma corrector 11, the color converter 13 as the image data conversion device, the gamma corrector 15, and the display unit 17 are same as those in the first embodiment, and the description thereof will not be repeated here.

The fourth color component (Y) of the second pixel data outputted from the color converter 13 is inputted to the sharpness unit 19. The sharpness unit 19 has a buffer and performs sharpening processing on an image formed of the plurality of fourth color components. The sharpening processing can employ conventionally well-known processing, for example, edge emphasizing processing for emphasizing edges.

The sharpness unit 19 is provided to perform sharpening processing only on yellow (Y) as the fourth color of the second pixel data, so as to obtain substantially similar effects as the case where the sharpening processing is performed on entire image data. Thus, the circuit configuration can be simplified and the cost can be reduced.

Note that in the second embodiment, the description has been given by using an example of the case where the fourth color is set to be yellow (Y), but a color other than yellow (Y), as long as it is a color having a relatively-high luminance value, can also obtain substantially similar effects as the case where the sharpening processing is performed on entire image data by providing the sharpness unit 11 only for the fourth color. In addition, different from the color converter 13 described in the first embodiment, a well-known color converter configured to convert values of three colors of R, G, and B into values of the three colors of R, G, and B and fourth color may be used for the color converter 13.

The embodiments disclosed in this specification are intended to merely describe the present invention exemplarily in all aspects, and it should not be understood that the embodiments are intended to limit the scope of the present invention. The scope of the present invention is intended to be defined not by the above description but by the scope of claims and to include all equivalents to and all modifications within the scope of the claims.

What is claimed is:

1. An image data conversion device, comprising:
an image data input unit to which image data formed of a plurality of first pixel data, each including values of three basic colors of red, green and blue, is inputted; and
a color converter configured to convert first pixel data into second pixel data including at least the values of the three basic colors and a value of a fourth color, by processing each of the plurality of first pixel data forming the image data, wherein
the color converter includes a controller configured to control changes in the value of the fourth color included in the second pixel data corresponding to the first pixel data, on the basis of the values of the three basic colors included in the first pixel data.

2. The image data conversion device according to claim 1, wherein the controller includes a first color controller configured to determine the value of the fourth color included in the second pixel data corresponding to the first pixel data to be smaller as chromaticity coordinates of the first pixel data is closer to chromaticity coordinates of white, and determine the value of the fourth color included in the second pixel data corresponding to the first pixel data to be larger as the chromaticity coordinates of the first pixel data is closer to the chromaticity coordinates of the fourth color.

3. The image data conversion device according to claim 1, wherein the controller includes a second color controller configured to determine the value of the fourth color included in the second pixel data to be smaller as the number of colors included in the inputted image data is larger.

4. The image data conversion device according to claim 1, wherein the color converter includes a gain-value determiner configured to determine a gain value in order to increase the value of the fourth color included in the second pixel data corresponding to the first pixel data, on the basis of the three basic colors included in the first pixel data.

5. The image data conversion device according to claim 4, wherein the controller includes a first gain-value controller configured to determine the gain-value in proportion to any one of each of the values of the three basic colors in the first pixel data and a luminance value specified by the values of the three basic colors included in the first pixel data, when each of the values of the three basic colors is in a predetermined range or when the luminance value specified by the values of the three basic colors is in a predetermined range.

6. The image data conversion device according to claim 4, wherein the controller includes a second gain-value controller configured to determine the gain-value to be smaller as the number of colors included in the inputted image data is larger.

7. The image data conversion device according to claim 1, further comprising a sharpness unit configured to sharpen an image formed of the value of the fourth color included in each of the plurality of second pixel data, acquired by converting the plurality of first pixel data with the color converter.

8. The image data conversion device according to claim 1, wherein the color converter includes:
a separator configured to separate the first pixel data into white component having same values of the three basic colors, and residual components other than the white components;
a white component converter configured to generate white component corresponding data including at least values of the three basic colors and fourth color on the basis of the white components separated by the separator;
a residual component converter configured to generate residual component corresponding data including at least values of the three basic colors and fourth color on the basis of the residual components separated by the separator; and
an addition unit configured to output the second pixel data, acquired by adding respective value of the same color, included in the white component corresponding data and the residual component corresponding data, wherein
the residual component converter includes the controller configured to control the changes in the value of the fourth color included in the second pixel data corresponding to the first pixel data on the basis of the values of the three basic colors included in the residual component corresponding data.

9. An image display device comprising:
the image data conversion device according to any one of claims 1 to 8; and
a display unit configured to display image data in which one pixel is formed of a plurality of colors including at least the three basic colors and the fourth color and which is outputted by the image data conversion device.
